(19) United States
(12) Patent Application Publication
(10) Pub. No.: US 2022/0139414 A1
(43) Pub. Date: May 5, 2022

(54) COMMUNICATION DEVICE AND SIDETONE VOLUME ADJUSTING METHOD THEREOF

(71) Applicant: PixArt Imaging Inc., Hsin-Chu County (TW)

(72) Inventors: Cheng-Te WANG, Taipei (TW); Jing-Wei LI, Taipei (TW); Kuo-Ping YANG, Taipei (TW)

(21) Appl. No.: 17/321,545

(22) Filed: May 17, 2021

(30) Foreign Application Priority Data
Nov. 4, 2020 (CN) 202011219114.7

(51) Int. Cl. G10L 21/034; G10L 25/51; G10L 21/0364

(52) U.S. Cl. CPC G10L 21/034; G10L 21/0364; G10L 25/51

(57) ABSTRACT

A communication device and a sidetone volume adjusting method thereof are disclosed. The communication device includes a sound processor, a far-end sound receiver, a near-end sound receiver, a volume adjuster, and a sound player. The far-end sound receiver is configured to receive a far-end sound and transmit it to the sound processor. The near-end sound receiver is configured to receive a near-end sound such that the sound processor receives the near-end sound to form a sidetone. The volume adjustment module is configured to adjust the volume of the far-end sound and the sidetone to form the adjusted far-end sound and the adjusted sidetone, wherein the volume of the adjusted sidetone is based on the near-end sound and the adjusted far-end sound. The sound player is used to play the adjusted sidetone and the adjusted far-end sound.

### BACKGROUND OF INVENTION

### 1. Field of the Invention

The present invention relates to a communication device and a sidetone volume adjusting method thereof, and more particularly to a communication device and a sidetone volume adjusting method to adjust the volume of the sidetone based on both the far-end sound and the near-end sound.

### 2. Description of Related Art

When communicating in a noisy environment, users often speak progressively louder because they cannot hear their own voices clearly. The microphone of the communication device can be used to pick up the sound of the user and play it to the loudspeaker to compensate for the voice heard by the user. This is called a sidetone. Since the user can hear his or her own voice, the appropriate sidetone volume can give the user a more natural sense of dialogue such that the user needs not speak progressively louder, which would otherwise make the noisy environment noisier and the communication partner receive a signal that is too loud.

The previous patents US20050177365A1 and U.S. Pat. No. 6,801,623B1 both disclose the technology of adjusting the volume of a sidetone according to the background noise or the volume of the microphone signal. However, if the adjustment of the sidetone volume only refers to the background noise or to the volume of the microphone signal, then in a very noisy environment, a relatively loud sidetone needs to be provided to the user, and it may not be able to make the user hear clearly in the noisy environment. In addition, the signal volume of the communication partner and the volume adjustment of the communication device may also affect the voice volume of the user.

Therefore, it is necessary to invent a new communication device and a method for adjusting the sidetone volume to solve the lack of the prior art.

### SUMMARY OF THE INVENTION

The main objective of the present invention is to provide a communication device which can adjust the sidetone based on both the far-end sound and the near-end sound.

Another main objective of the present invention is to provide a method for adjusting the sidetone volume of the above-mentioned device.

To achieve the above objective, the communication device of the present invention comprises a sound processor, a far-end sound receiver, a near-end sound receiver, a volume adjuster, and a sound player. The far-end sound receiver is electrically connected to the sound processor to receive the far-end sound wirelessly or over wires, and transmit the far-end sound to the sound processor. The near-end sound receiver is electrically connected to the sound processor to detect the near-end sound and make the sound processor receive the near-end sound to form a sidetone. The volume adjuster is electrically connected to the sound processor to adjust the volume of the far-end sound through the control of the sound processor to form an adjusted far-end sound, and the volume adjuster further adjusts the sidetone volume through the control of the sound processor to form the adjusted sidetone, wherein the volume of the adjusted sidetone is determined by the near-end sound and the adjusted far-end sound. The sound player is electrically connected to the sound processor to play the adjusted sidetone and the adjusted far-end sound.

The method for adjusting the sidetone volume of the present invention includes the following steps: receiving the far-end sound wirelessly or over wires; detecting the near-end sound to form the sidetone; adjusting the volume of the far-end sound to form the adjusted far-end sound; adjusting the sidetone volume to from the adjusted sidetone, wherein the volume of the adjusted sidetone is determined by the near-end sound and the adjusted far-end sound; and outputting the adjusted sidetone and the adjusted far-end sound.

### BRIEF DESCRIPTION OF THE DRAWINGS

FIG. 1A is a schematic diagram of the architecture of the communication device of the present invention.

FIG. 1B is a schematic diagram of the communication device of the present invention in a different embodiment.

FIG. 2 is a flow chart of the method for adjusting the sidetone volume of the present invention.

### DETAILED DESCRIPTION OF THE INVENTION

In order to allow the reviewers to better understand the technical content of the present invention, a preferred specific embodiment is described as follows.

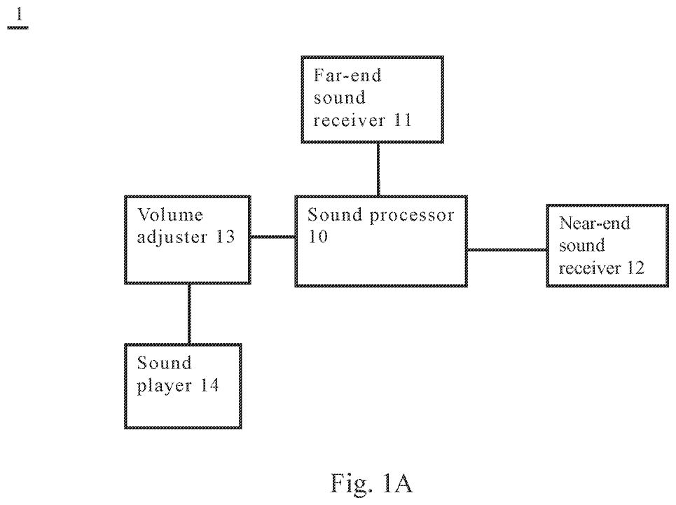

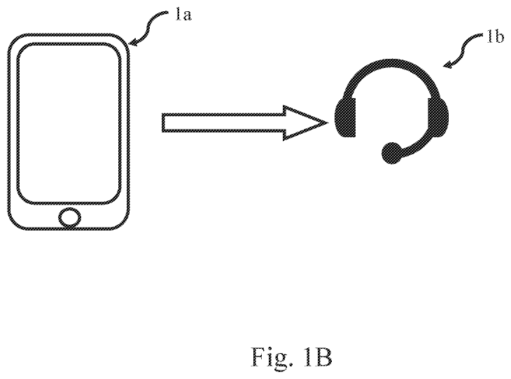

Please refer to FIG. 1A for the schematic diagram of the architecture of the communication device of the present invention.

In one embodiment of the present invention, the communication device 1 can be a smart phone or a smart wearable device (such as a headset). The communication device 1 comprises a sound processor 10, a far-end sound receiver 11, a near-end sound receiver 12, a volume adjuster 13, and a sound player 14. The sound processor 10 can be constructed of a hardware device, a software program combined with a hardware device, or firmware combined with a hardware device, etc., and is used for processing all the audio signals received from the communication device 1. The far-end sound receiver 11 is electrically connected to the sound processor 10 for receiving a far-end sound and transmitting the far-end sound to the sound processor 10. In one embodiment of the present invention, the communication device 1 can be a smart phone 1a (as shown in FIG. 1B), and the far-end sound is the sound emitted by the communication partner of the communication device 1. Therefore, the far-end sound receiver 11 is a wireless signal receiving module that can receive signals of mobile communication standards such as GSM, 2G, or 3G, or wireless signals such as Wi-Fi, Bluetooth, etc. The present invention does not limit the signal modes that are applicable to the far-end sound receiver 11. Please also refer to FIG. 1B, which is a schematic diagram of the communication device of the present invention in a different embodiment. In another embodiment of the present invention, the communication device 1 may also be a headset 1b connected to the smart phone 1a. The sound signal received by the smart phone 1a via the cellular network is then transmitted to the headset 1b wirelessly or over wires. Therefore, the current far-end sound is the sound transmitted from the smart phone 1a wirelessly or over wires.

The near-end sound receiver 12 is electrically connected to the sound processor 10 and can be a microphone for receiving a near-end sound. The near-end sound is the sound received by the near-end sound receiver 12 when the user is talking. After receiving the near-end sound, the near-end sound receiver 12 will transmit it to the sound processor 10 to process the near-end sound into a sidetone. The sidetone is the auditory feedback of a speaking person, and the source is the user's own voice. Therefore, the sidetone volume is related to the volume of the speech of the user. The volume adjuster 13 is electrically connected to the sound processor 10 to adjust the volume of the far-end sound through the control of the sound processor 10 to form an adjusted far-end sound. The sound processor 10 can determine whether the user is in a quiet or noisy environment from the magnitude of the ambient sound received by the near-end sound receiver 12, and then the sound processor 10 can adjust the volume of the far-end sound synchronously to allow the user to hear the far-end sound more clearly. It should also be noted that the sound processor 10 can also perform adjustments according to the user's preferences or other conditions, such as manual adjustment by the user. The present invention is not limited to the items listed above. In addition, the volume adjuster 13 further adjusts the sidetone volume through the control of the sound processor 10 to form an adjusted sidetone. Finally, the sound player 14 is a loudspeaker, which is electrically connected to the sound processor 10 to play the adjusted sidetone and the adjusted far-end sound.

Since the adjusted far-end sound can be used as a reference for the sensitivity of a user's hearing when affected by the background noise during communication, that is, the user's appropriate dynamic output volume in this environment, then a louder the background noise will result in a louder user's adjusted far-end sound. The sound processor 10 determines the volume of the adjusted sidetone to be adjusted by the volume adjuster 13 according to the near-end sound and the adjusted far-end sound, so the volume of the adjusted sidetone will be related to the volume of the near-end sound or the volume of the adjusted far-end sound. When the volume of the near-end sound is louder or the volume of the adjusted far-end sound is louder, the volume of the sidetone after adjustment by the volume adjuster 13 is also louder. Conversely, if the volume of the near-end sound or the volume of the adjusted far-end sound is lower, the volume of the adjusted sidetone is also lower. In this way, on the one hand, the user can appropriately sense whether the volume of the near-end sound emitted is too loud according to the volume of the adjusted sidetone. On the other hand, the volume of adjusted sidetone will also be adjusted according to the volume of the adjusted far-end sound, so if the user reduces the volume of the near-end sound, the volume of the adjusted sidetone will not be adjusted too low.

It should be noted that each module of the communication device 1 can be constructed by a hardware device, a software program combined with a hardware device, or firmware combined with a hardware device, etc., but the present invention is not limited to the above modes. In addition, this embodiment only illustrates a preferred embodiment of the present invention, and in order to avoid repetition, not all possible variations and combinations are described in detail. However, those skilled in the art should understand that not all of the above-mentioned modules or components are necessary. Moreover, for the implementation of the present invention, other more detailed conventional modules or components may be included. Each module or component may be omitted or modified as required, and other modules or components may be present between any two modules.

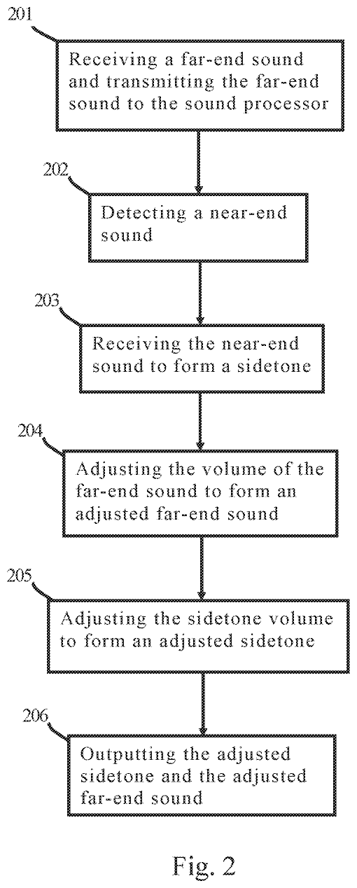

Next please refer to FIG. 2, which is a flow chart of the method for adjusting the sidetone volume of the present invention. It should be noted here that although the communication device 1 described above is used as an example to describe the method of adjusting the sidetone volume of the present invention, the method of adjusting the sidetone volume of the present invention is not limited to the communication device 1 with the same structure as described above.

The method begins with step 201: Receiving a far-end sound and transmitting the far-end sound to the sound processor.

The far-end sound receiver 11 receives a far-end sound from the other party through a wired or wireless communication path and transmits the far-end sound to the sound processor 10.

The method proceeds with step 202: Detecting a near-end sound.

The near-end sound receiver 12 detects a near-end sound from the user, and the order of step 201 and step 202 can also be reversed.

Then the method proceeds to step 203: Receiving the near-end sound to form a sidetone.

After receiving the near-end sound and transmitting to the sound processor 10, the sound processor 10 will process the near-end sound into a sidetone.

Next, the method proceeds to step 204: Adjusting the volume of the far-end sound to form an adjusted far-end sound.

The volume adjuster 13 adjusts the volume of the far-end sound through the control of the sound processor 10 to form an adjusted far-end sound. The sound processor 10 can be adjusted according to the volume of the ambient sound, user preferences or other conditions. The present invention is not limited thereto.

The method simultaneously proceeds to step 205: Adjusting the sidetone volume to form an adjusted sidetone.

The volume adjuster 13 further adjusts the sidetone volume through the control of the sound processor 10 to form an adjusted sidetone. The sound processor 10 determines the volume of the adjusted sidetone to be adjusted by the volume adjuster 13 according to the near-end sound and the adjusted far-end sound. Therefore, when the volume of the near-end sound is louder, the volume of the adjusted sidetone set by the volume adjuster 13 is louder. When the volume of the adjusted far-end sound is louder, the volume of the adjusted sidetone set by the volume adjuster 13 is also louder.

Finally, the method proceeds to step 206: Outputting the adjusted sidetone and the adjusted far-end sound.

Finally, the adjusted sidetone and the adjusted far-end sound are output to the sound player 14 to allow it to be played such that the user can moderately sense the volume of the near-end sound emitted by himself or herself according to the volume of the adjusted sidetone.

It should be noted here that the method of adjusting the sidetone volume of the present invention is not limited to the above-mentioned sequence of steps. As long as the purpose of the invention can be achieved, the above-mentioned sequence of steps can be altered.

It can be seen from the above description that the communication device 1 of the present invention can adjust the sidetone volume according to the volume of the far-end sound emitted by the communication partner and simultaneously adjust the sidetone volume by referring to the volume of the near-end sound emitted by the user to provide the user with the best sidetone compensation when the user is communicating in a noisy environment.

Although the invention has been explained in relation to its preferred embodiment, it is to be understood that many other possible modifications and variations can be made without departing from the spirit and scope of the invention as hereinafter claimed.

What is claimed is:

1. A method for adjusting the volume of a sidetone includes:
receiving a far-end sound wirelessly or over wires;
detecting a near-end sound to form a sidetone;
adjusting the volume of the far-end sound to form an adjusted far-end sound;
adjusting the sidetone volume to form an adjusted sidetone, wherein the volume of the adjusted sidetone is determined by the near-end sound and the adjusted far-end sound; and
outputting the adjusted sidetone and the adjusted far-end sound.

2. The method for adjusting the volume of sidetone defined in claim 1, wherein when the volume of the near-end sound is louder, the volume of the adjusted sidetone is louder.

3. The method for adjusting the volume of sidetone defined in claim 2, wherein when the volume of the adjusted far-end sound is louder, the volume of the adjusted sidetone is louder.

4. A communication device comprising:
a sound processor;
a far-end sound receiver, which is electrically connected to the sound processor to receive a far-end sound wirelessly or over wires and transmit the far-end sound to the sound processor;
a near-end sound receiver, which is electrically connected to the sound processor to detect the near-end sound and make the sound processor receive the near-end sound to form a sidetone;
a volume adjuster, which is electrically connected to the sound processor to adjust the volume of the far-end sound through the control of the sound processor to form an adjusted far-end sound, and the volume adjuster further adjusts the sidetone volume through the control of the sound processor to form an adjusted sidetone, wherein the volume of the adjusted sidetone is determined by the near-end sound and the adjusted far-end sound; and
a sound player, which is electrically connected to the sound processor for playing the adjusted sidetone and the adjusted far-end sound.

5. The communication device defined in claim 4, wherein when the volume of the near-end sound is louder, the volume of the adjusted sidetone is louder.

6. The communication device defined in claim 5, wherein when the volume of the adjusted far-end sound is louder, the volume of the adjusted sidetone is louder.
